(19) United States
(12) Patent Application Publication
(10) Pub. No.: US 2023/0304338 A1
(43) Pub. Date: Sep. 28, 2023

(54) HINGE

(71) Applicant: FAKRO PP Sp. z o. o., Nowy Sacz (PL)

(72) Inventor: Bartlomiej Mos, Nawojowa (PL)

(73) Assignee: FAKRO PP Sp. z o. o., Nowy Sacz (PL)

(21) Appl. No.: 18/119,608

(22) Filed: Mar. 9, 2023

(30) Foreign Application Priority Data
Mar. 24, 2022 (PL) P.440752

(51) Int. Cl. E05D 3/18; E05D 3/16

(52) U.S. Cl. CPC E05D 3/18; E05D 3/16; E04F 11/064

(57) ABSTRACT

A hinge is configured for attaching at least two components of a structural element, a fixed component and an articulated component, and is constructed out of assembly hanger designed for mounting the hinge to fixed component, at least one base coupler rotatably attached to assembly hanger, so that, the swivel axle of that attachment runs through top pin, through which base coupler is attached to assembly hanger and assembly hanger includes race for travelling pin, determining the position of the variable swivel axle of articulated component relative to fixed component attached to one another via the hinge.

### CROSS REFERENCE TO THE RELATED APPLICATIONS

This application is based upon and claims priority to Polish Patent Application No. 440752, filed on Mar. 24, 2022, the entire contents of which are incorporated herein by reference.

### TECHNICAL FIELD

The object of the present invention is a hinge connecting a fixed and an articulated components of a structural element and in particular of attic stairs.

### BACKGROUND

Attic stairs which include three segments of ladder stairs, attached using hinges have been disclosed in patent description PL229816B1. The first segment of the stairs is pivotally attached to the framework via hinge brackets, fastened from the inside to framework wall wherein when unfolding these stairs, the swivel axle of the first segment of the stairs does not change its position relative to the framework. A hatch is suspended from the first segment of stairs using at least two pairs of connectors, which together with the first segment of the stairs and the hatch constitute a four-bar linkage system.

The disclosed box structure hinge makes it possible to distance the attic stairs hatch which is an articulated component of a structural element from a segment of the ladder stairs which is convenient during their use, as the user's foot has more room for a stable placement on a rung. When closing the attic stairs, the gap between a ladder segment and the hatch decreases, but is not eliminated. This causes logistical problems, as such stairs require more space during transport restricting transport options.

### SUMMARY

The hinge according to the present invention solves the aforementioned problem through characteristics indicated in the first patent claim. The essence of the solution includes a hinge for attaching at least two components of a structural element, a fixed component and an articulated component. The hinge is constructed out of an assembly hanger, which constitutes the assembly base for the remaining hinge elements, such as base coupler with a top and a bottom pin. The base coupler and the assembly hanger are rotatably attached, wherein the swivel axle for this attachment runs through the top pin of the base coupler. The bottom pin of the base coupler connects the assembly hanger with the articulated component of the structural element. The hinge also includes a travelling pin, which moves in the assembly hanger race when the structural element is in use, moving the articulated component relative to the assembly hanger and the fixed component. Together with the travelling pin movement in the race, the articulated component swivel axle position changes relative to the fixed component attached to each other via the hinge. Preferably the race is in the shape of an arch, straight or curved. The race features an insert made of plastic in order to reduce friction between the travelling pin and the race. The hinge may also include a second coupler immovably mounted on the articulated component, whilst at the same time including an articulated attachment with the hinge. The aforementioned articulated attachment between the second coupler and the hinge is achieved by attaching the first end of the second coupler to the assembly hanger via the hinge travelling pin and by attaching the other end to the base coupler via the bottom pin of the base coupler. The travelling pin may at the same time be mounted directly on the articulated component. The hinge also includes at least two additional couplers for an additional articulated component to be suspended from them and the hinge. Two ends of the additional couplers are joined by an articulated attachment, and a free end of one of the additional couplers is designed for an articulated attachment with the assembly hanger, whereas the free end of the other additional coupler is designed for an articulated attachment with an additional articulated component. An additional articulated component may also be mounted directly to the attic stairs box without additional couplers. When opening the structural element, due to the assembly hanger race, the hinge lowers the articulated component, distancing it from the fixed component and the additional articulated component. In a preferable version of the present invention, the aforementioned free end of the second additional coupler terminates with a hook part, and in particular with a hook to be suspended on the pin of the bracket mounted on the additional articulated component. The bracket is constructed out of a base and a lock, which include a working part in the form of a coaxial hole into which the aforementioned pin is inserted. The construction of each hook and bracket makes it possible to detach the additional articulated component from the fixed component or to lock it in the structural element use position. Preferably the attachment between the free end of the additional coupler with the assembly hanger is smoothly adjustable attachment, wherein the attachment is adjusted via an eccentric sleeve or an eccentric rivet. An adjustable attachment makes it possible to adjust the position of the additional articulated component relative to the articulated component and the fixed component of the structural element. This adjustment helps to eliminate gaps which appear between the additional articulated component and the fixed component. Preferably the hinge couplers are connected to one another and to the hanger using rivets.

Due to the assembly hanger race, the ladder stairs segments not only execute a rotational movement but also a slide movement relative to the attic stairs box. This has consequences in the form of benefits of the present invention, and namely distancing attic stairs ladder segments from the closing hatch and thus creating space for the user's foot when climbing and descending along the segments, and also bringing retracted ladder stair segments as close as possible to the attic stairs hatch in its closed position.

### BRIEF DESCRIPTION OF THE DRAWINGS

The illustration depicts the present invention, with given figures depicting the following:

FIG. 1 is a spatial view of attic stairs,

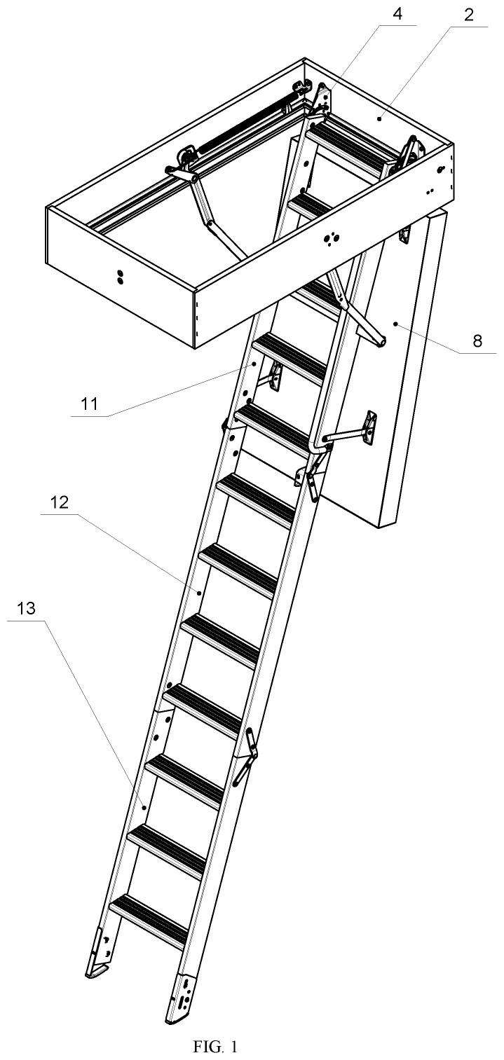

FIG. 2 is a side view of unfolded attic stairs and hinge,

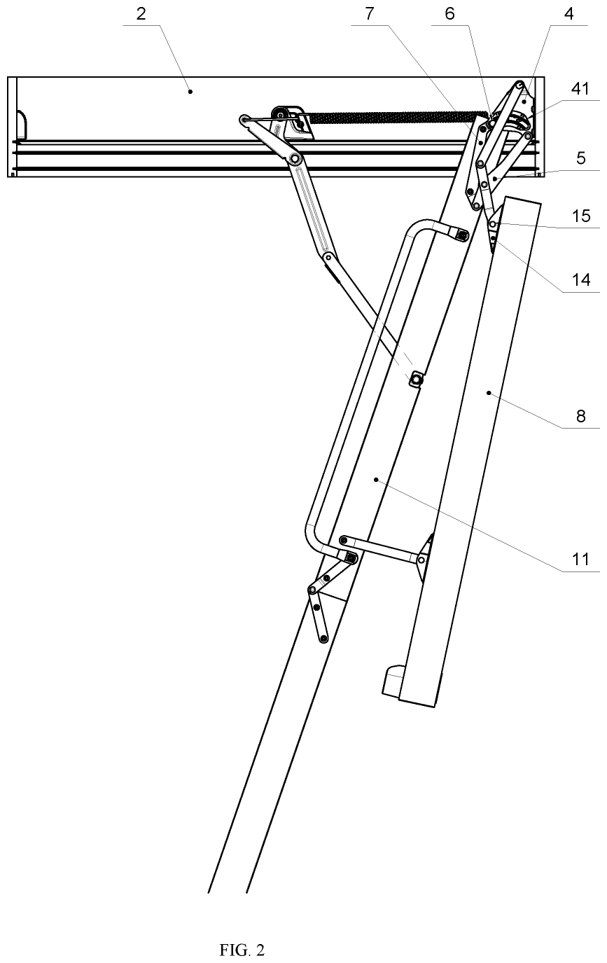

FIG. 3 is a side view of partially retracted attic stairs and hinge,

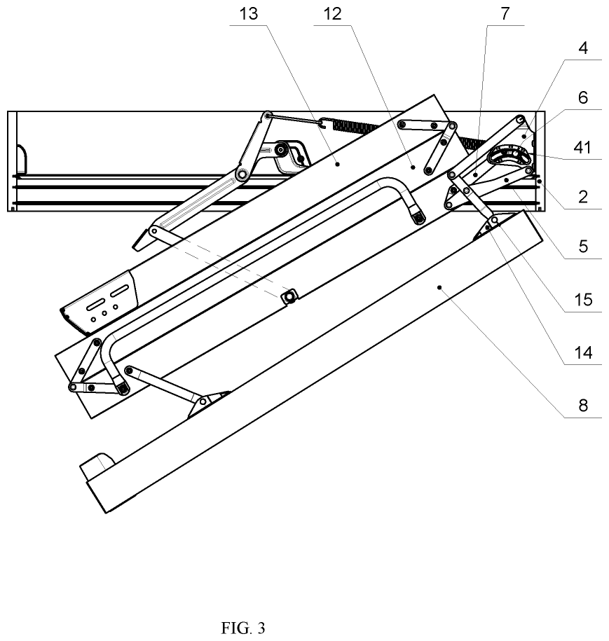

FIG. 4 is a side view of retracted attic stairs and hinge,

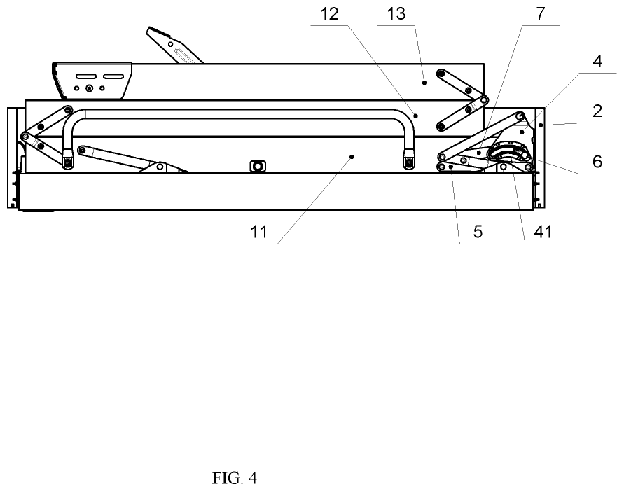

FIG. 5 is a spatial view of attic stairs hinge in an unfolded position, and

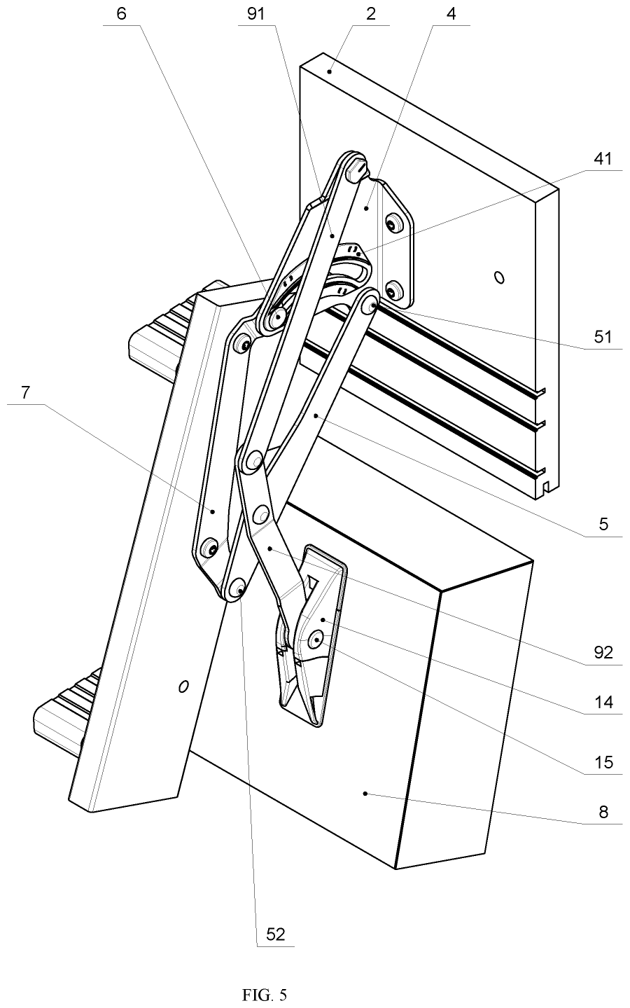

FIG. 6 is a spatial view of attic stairs hinge in a retracted position.

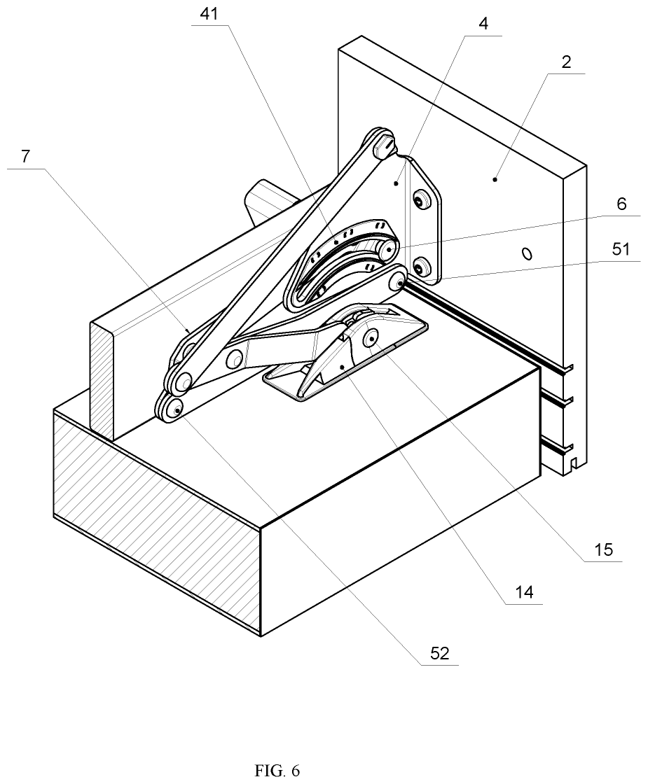

### DETAILED DESCRIPTION OF THE EMBODIMENTS

Embodiments will be presented on a structural element, namely attic stairs, with their stairs ladder segments 11, 12, 13 as the stairs articulated component, and stairs box 2 is their fixed component, whereas closing hatch 8 is the additional articulated component.

In the first embodiment, the attic stairs hinge is constructed out of assembly hanger 4 mounted on the inside surface of attic stairs box 2. Assembly hanger 4 is attached to an articulated component in the form of first ladder segment 11 via base coupler 5 with top pin 51 and bottom pin 52. The swivel axle of base coupler 5 relative to assembly hanger 4 runs through top pin 51. The hanger includes an arm with race 41 for travelling pin 6 mounted on first attic stairs segment 11. In the attic stairs retracted position, travelling pin 6 is at one end of arch shaped race 41. During unfolding of attic stairs, and thus while lowering the articulated component (downwards), travelling pin 6 moves along race 41 towards its other end, and top pin 51 of base coupler 5 executes a rotational movement together with first ladder segment 11. Travelling pin 6 is at the first end of second coupler 7 of the hinge which is attached in a fixed manner to first segment 11 of the attic stairs. The other end of second coupler 7 is attached to base coupler 5 bottom pin 52. In this manner there is an articulated attachment between first stairs segment 11 and stairs box 2 via the hinge. Attic stairs hatch 8 constitutes an additional articulated component, which may be mounted on box 2, where the said hatch 8 is mounted on the stairs hinge using a pair of additional couplers 91 and 92. Additional couplers 91, 92 make an articulated pair of couplers, attached at one point, whereas one of the couplers is suspended on assembly hanger 4 and the other is suspended on the hatch using bracket 14 with coupling pin 15.

In the second embodiment, not shown on the illustration, the travelling pin is mounted directly to the first ladder segment without using a second coupler.

What is claimed is:

1. A hinge for attaching at least two components of a structural element, a fixed component and an articulated component, comprising an assembly hanger designed for mounting the hinge to the fixed component, at least one base coupler rotatably attached to the assembly hanger, wherein a swivel axle of an attachment between the at least one base coupler and the assembly hanger runs through a top pin, the at least one base coupler is attached to the assembly hanger through the top pin, wherein the assembly hanger comprises a race for a travelling pin, determining a position of the variable swivel axle of the articulated component relative to the fixed component attached to one another via the hinge.

2. The hinge according to claim 1, wherein the hinge comprises a second coupler, wherein the second coupler is immovably attached to the articulated component and attached in an articulated manner to the hinge.

3. The hinge according to claim 1, wherein a first end of a second coupler is attached to the assembly hanger via the travelling pin of the hinge, and a second end of the second coupler is attached to the at least one base coupler via a bottom pin.

4. The hinge according to claim 1, wherein the travelling pin is located on the articulated component.

5. The hinge according to claim 1, wherein the hinge comprises at least two additional couplers for suspending an additional articulated component on the hinge, wherein ends of the at least two additional couplers are joined by an articulated attachment, and a free end of a first additional couplers is designed for an articulated attachment with the assembly hanger, and a free end of a second additional coupler is designed for an articulated attachment with the additional articulated component.

6. The hinge according to claim 5, wherein the free end of the second additional coupler is terminated with a hook part, and in particular with a hook for suspending the additional articulated component.

7. The hinge according to claim 5, wherein the articulated attachment of the free end of the first additional coupler with the assembly hanger is a smoothly adjustable attachment.

8. The hinge according to claim 5, wherein the articulated attachment is adjusted using an eccentric sleeve or an eccentric rivet.

9. The hinge according to claim 1, wherein the race is in a shape of an arch.

10. The hinge according to claim 1, wherein the race is straight.

11. The hinge according to claim 1, wherein the race is curved.

12. The hinge according to claim 1, wherein an insert made out of plastic is provided in the race.

13. The hinge according to claim 2, wherein the first end of the second coupler is attached to the assembly hanger via the travelling pin of the hinge, and a second end of the second coupler is attached to the at least one base coupler via a bottom pin.

14. The hinge according to claim 2, wherein the hinge comprises at least two additional couplers for suspending an additional articulated component on the hinge, wherein ends of the at least two additional couplers are joined by an articulated attachment, and a free end of a first additional couplers is designed for an articulated attachment with the assembly hanger, and a free end of a second additional coupler is designed for an articulated attachment with the additional articulated component.

15. The hinge according to claim 3, wherein the hinge comprises at least two additional couplers for suspending an additional articulated component on the hinge, wherein ends of the at least two additional couplers are joined by an articulated attachment, and a free end of a first additional couplers is designed for an articulated attachment with the assembly hanger, and a free end of a second additional coupler is designed for an articulated attachment with the additional articulated component.

16. The hinge according to claim 4, wherein the hinge comprises at least two additional couplers for suspending an additional articulated component on the hinge, wherein ends of the at least two additional couplers are joined by an articulated attachment, and a free end of a first additional couplers is designed for an articulated attachment with the assembly hanger, and a free end of a second additional coupler is designed for an articulated attachment with the additional articulated component.

17. The hinge according to claim 6, wherein the articulated attachment of the free end of the first additional coupler with the assembly hanger is a smoothly adjustable attachment.

18. The hinge according to claim 6, wherein the articulated attachment is adjusted using an eccentric sleeve or an eccentric rivet.

19. The hinge according to claim 7, wherein the articulated attachment is adjusted using an eccentric sleeve or an eccentric rivet.

20. The hinge according to claim 2, wherein an insert made out of plastic is provided in the race.
